(19) United States
(12) Patent Application Publication
(10) Pub. No.: US 2007/0040356 A1
(43) Pub. Date: Feb. 22, 2007

(54) Towing device

(76) Inventor: Carl Douglas Fitt, Auckland (NZ)

Correspondence Address: YOUNG & THOMPSON, 745 SOUTH 23RD STREET, 2ND FLOOR, ARLINGTON, VA, 22202, US

(21) Appl. No.: 11/491,179

(22) Filed: Jul. 24, 2006

(30) Foreign Application Priority Data
Jul. 22, 2005 (NZ) 541400
Oct. 28, 2005 (NZ) 543284

(51) Int. Cl. B60D 1/04

(52) U.S. Cl. 280/514

(57) ABSTRACT

The invention comprises a tow hitch having a base member, first engagement means capable of engaging, in use, a selected part of a wheelie bin or the like object. The first engagement means may be provided on or forming part of the base member. Second engagement means, on and/or forming part of the base member are also provided. The second engagement means are in use with a towing hitch on a vehicle, whereby the vehicle may be used to tow the wheelie bin or the like object. A tow ball construction temporarily engageable on a towing vehicle is also described.

This invention relates to a tow hitch and has been designed particularly though not necessarily solely for use in towing bins of the type generally known as wheelie bins.

Wheelie bins have become substantially ubiquitous in many countries including New Zealand. In many properties it is necessary to move a wheelie bin a substantial distance between the position where it normally sits on a persons property and the side of the road where it is collected by the passing waste disposal vehicle. Moving the wheelie bins can be difficult for most people but this is particularly so where the user of the bin is elderly or infirm, where the ground over which the bin must be moved is steep or uneven, or where the distances that the bin must be moved is large. This is clearly disadvantageous.

It is therefore an object of the present invention to provide a tow hitch which will obviate or minimise the foregoing disadvantages in a simple yet effective manner or which will at least provide the public with a useful choice.

Accordingly, the invention consists in a tow hitch comprising a base member, first engagement means capable of engaging, in use, a selected part of a wheelie bin or the like object, and/or the first engagement means being on and/or forming part of the base member, and second engagement means, on and/or forming part of the base member, engageable in use with a towing hitch on a vehicle, whereby the vehicle may be used to tow the wheelie bin or the like object.

Preferably, the second engagement means is capable of engaging and disengaging the towing hitch without the operation of any mechanical mechanism.

Preferably, the second engagement means comprises a plate forming part of the base member and an aperture in the plate, the aperture being capable in use of passing over a ball forming part of the vehicle tow hitch.

Preferably, the aperture has a narrower part sized such the ball of the vehicle tow hitch part will not pass through the narrower part but sized such that the neck of the ball forming part of the vehicle tow hitch can become positioned in the narrower part of the aperture during towing of the wheelie bin or the like object by the vehicle.

Preferably, a second narrower part is provided to allow the bin to be pushed in use by the vehicle.

Preferably, the first engagement means comprises one or more split collars able to pass around a handle or handles forming part of the wheelie bin or like object.

Alternatively the second engagement means engages means providing a tow ball and operable to clamp onto part of a towing vehicle in use.

Preferably the means able to clamp onto a towing vehicle comprises a suction cup.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

One preferred form of the invention will now be described with reference to the accompanying drawings, in which,

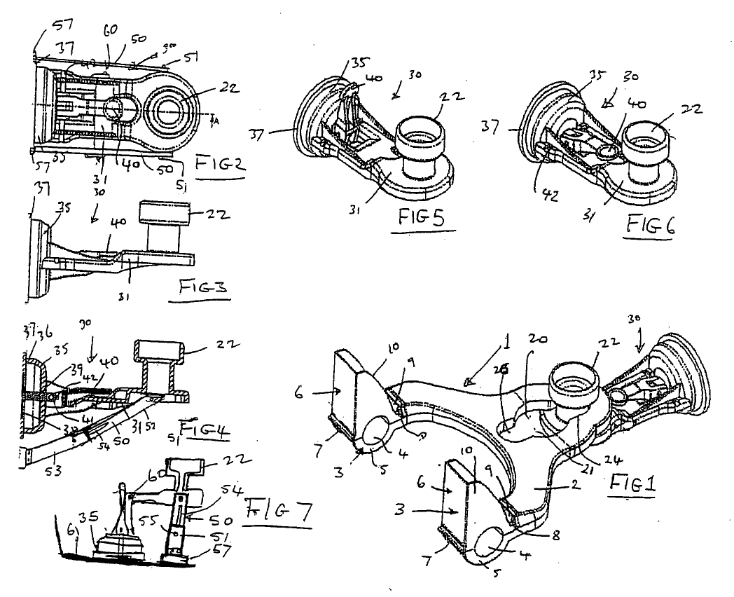

FIG. 1 is a perspective view of a tow hitch assembly according to one preferred form of the invention,

FIG. 2 is a plan view of part of the tow hitch assembly of FIG. 1 including a brace,

FIG. 3 is a side elevation of a part of a tow hitch the assembly according to the preferred form of the invention,

FIG. 4 is a cross section on “A-A” in FIG. 2,

FIG. 5 is a perspective view of the part of the tow hitch shown in FIG. 2 in a release mode,

FIG. 6 is a view as in FIG. 5 with the tow hitch part in a suction mode, and

FIG. 7 is a diagrammatic side view of the embodiment of the invention including the brace.

Referring to the drawings a tow hitch 1 is provided as follows.

The tow hitch has a base member 2 which may be substantially planar and formed of any suitable material such as a suitable metal or plastics material.

First engagement means are provided either on the base member 2 or forming part of the base member 2. In the preferred embodiment, shown in the drawings, the first engagement means are provided by a pair of split collars 3 which can be opened to enable a handle or handles of a wheelie bin or the like to be positioned in the aperture 4 in the handles 3. In the embodiment shown in FIG. 1 the base plate 2 is formed to substantially a semi circular part 5 and then connected to a further semi circular part 6 through for example, a hinge 7.

In order for the collar so formed to be closed an outward flange 8 may be provided on the part 6 which can be a ‘snap’ fit below a rib 9 on the base member 2. The part 6 may have an outwardly extending member 10 to enable some leverage to be applied to the part 6 to snap the flange 8 under the rib 9 or to remove the flange 8 from the rib 9.

Second engagement means are provided on, or as part of, the base member 2, and in the preferred embodiment the second engagement means comprises an aperture 20, a part 21 of which is sized so that a tow ball 22 forming part of a vehicle tow ball hitch may pass through the part 21.

A narrower part 24 is provided into which in use the neck 25 of the vehicle tow hitch becomes positioned.

The aperture 20 may have an opposite narrow part 26 to, in use, allow the bin to be pushed by the vehicle. The tow ball 22 may be a substantially permanent fixture on the towing vehicle or may be on a separate member attachable to the vehicle as described hereunder.

FIG. 1 in part and FIGS. 2 to 6 show a towing device 30 which is able to be temporarily fixed to a towing vehicle in use. The towing device 30 is formed for example from a robust plastics material and has a base plate 31 which carries the tow ball 22.

A dished member 35 is provided at or adjacent the opposite end 36 of the base plate 31 from the tow ball 22. Secured to the periphery (or adjacent thereto) is a flexible diaphragm 37. The diaphragm 37 has secured therein or thereon a fixing member such as plate 38 from which extends link 39. The link 39 is attached to a camming lever 40 by a pivot pin at 41. The camming lever 40 is pivotally mounted on the base plate 31 by a pivot pin 42.

When the camming lever 40 is moved from the position shown in FIG. 6 to the position shown in FIG. 5 the diaphragm 37 is moved into the dished member 35 lowering the air pressure between the diaphragm 37 a surface against which the diaphragm 37 is pressed. Thus the towing device 30 can be mounted on a vehicle. Returning the camming lever 40 to the position in FIG. 6 will release the towing device from the vehicle.

The diaphragm 37 could be replaced by a piston sealed to the dish shaped member 35, for example, by an “o” ring. In such case the dish shaped member would need to be cylindrical at least over the range of movement of the piston in use.

In use the first engagement means is opened so that the collars can be placed around a handle or the handles of a wheelie bin or the like object, then closed and secured by snapping the flange 8 over the rib 9. Of course any other fixing means that is capable of securing the handles in the collars 3 can be used.

The tow hitch 1 can be a relatively loose connection to the handles or can be tightly clamped as desired.

When it is desired to move the wheelie bin, the bin is tilted so that the part 21 of the aperture 20 can be passed over the tow ball 22. Pulling the wheelie bin a little away from the vehicle will cause the neck of the vehicle tow hitch 23 to become positioned in the part 24. The wheelie bin or the like object can then be towed by the vehicle to the desired position. As the vehicle is towing the wheelie bin or the like object the tendency will be for the neck to remain in the aperture part 24 so as to retain a connection between the towing vehicle and the wheelie bin. In some instances it may be desirable to push the wheelie bin perhaps for a short distance to accurately locate it in which circumstances the neck will become positioned in the aperture part 26. The part 26 also receives the neck when pulling the bin downhill, should the bin push up against the towing vehicle.

If the vehicle has no tow ball then the towing device. 30 may be secured to the vehicle as above described and the tow hitch used by attachment to the towing device 30.

To remove the wheelie bin from engagement with the vehicle a little adjustment of the wheelie bin position will enable the base plate 2 to be removed from the tow ball 22 by passing the tow ball 22 outwardly through aperture part 21.

In the embodiments of FIGS. 2, 4 and 7 one or more such as two braces 50 are shown.

The brace is pivotally connected to the device 30 near the ball 22, for example, by a pivot pin 51. The brace includes an arm 52 which is preferably adjustable in length, for example, by providing telescopic members 52 and 53. The telescopic members 52, 53 may be adjusted by providing a slot 54 on one member and a member such as bolt 55 passing through the arm part 53 and through the slot 54 to be secured, for example, by a wing nut (not shown).

A foot 57 is pivotally attached to an arm part 53. Thus the braces 50 may provide additional support for the device.

If the member 30 is provided in two parts, connected for example at 60 by a pivot pin or other hinge the suction dish 35 may also be connected in use to a substantially horizontal member 61 on the vehicle. The adjustable length of arm 50 allows members at other angles to be similarly engaged.

The operation can be repeated as required.

Thus it can be seen that at least in the preferred form of the invention a tow hitch is provided which will enable a wheelie bin or the like object to be readily moved by means of a construction which can be attached to a vehicle without the necessity of operating any mechanical locking mechanism. Accordingly, therefore the device can be quickly and accurately used to engage the wheelie bin or the like object with the towing vehicle. Equally the tow hitch can be readily removed from the towing vehicle when desired.

It will be appreciated that it is not necessary to remove the tow hitch 1 from the wheelie bin or like objects between uses thereof, which is a particular advantage of the invention as the tow hitch 1 can remain engaged with the wheelie bin or the like device.

What I claim is:

1. A tow hitch comprising a base member, first engagement means capable of engaging, in use, a selected part of a wheelie bin or the like object, and/or the first engagement means being on and/or forming part of the base member, and second engagement means, on and/or forming part, of the base member, engageable in use with a towing hitch on a vehicle, whereby the vehicle may be used to tow the wheelie bin or the like object.

2. A tow hitch as claimed in claim 1 wherein the second engagement means is capable of engaging and disengaging the towing hitch without the operation of any mechanical mechanism.

3. A tow hitch as claimed in claim 2 wherein the second engagement means comprises a plate forming part, of the base member and an aperture in the plate, the aperture being capable in use of passing over a ball forming part of the vehicle tow hitch.

4. A tow hitch as claimed in claim 1 wherein the aperture has a narrower part sized such the ball of the vehicle tow hitch part will not pass through the narrower part but sized such that the neck of the ball forming part of the vehicle tow hitch can become positioned in the narrower part of the aperture during towing of the wheelie bin or the like object by the vehicle.

5. A tow hitch as claimed in claim 4 wherein a second narrower part is provided to allow the bin to be pushed in use by the vehicle.

6. A tow hitch as claimed in claim 1 wherein the first engagement means comprises one or more split collars able to pass around a handle or handles forming part of the wheelie bin or like object.

7. A tow hitch as claimed in claim 1 wherein the second engagement means engages means providing a tow ball and operable to clamp onto part, of a towing vehicle in use.

8. A tow hitch as claimed in claim 7 wherein the means able to clamp onto a towing vehicle comprises a suction cup.
